(19) United States
(12) Patent Application Publication
(10) Pub. No.: US 2004/0089173 A1
(43) Pub. Date: May 13, 2004

(54) Web-fed rotary press

(76) Inventors: Matthias Willi Horn, Hofheim (DE); Klaus Georg Matthias Muller, Remlingen (DE)

Correspondence Address: Douglas R Hanscom, Jones Tullar & Cooper, P.O. Box 2266, Eads Station, Arlington, VA, 22202, US

(21) Appl. No.: 10/470,741

(22) PCT Filed: Sep. 27, 2001
(86) PCT No.: PCT/DE01/03734

(30) Foreign Application Priority Data
Feb. 9, 2001 (DE) 101 05 926.4

(51) Int. Cl. B41F 5/16

(52) U.S. Cl. 101/180

(57) ABSTRACT

The invention related to a web-fed rotary press for printing a web. Said press comprising at least two satellite cylinders (06,08) and at least six cylinders (03,07), each of which forms a printing point (D1 to D6) with the satellite cylinders. According to the invention, each printing point can be brought into a printing-on and printing-off position. The six or more printing points can be positioned on the same side of the web (04), whereby at least five of the printing points that can be positioned on the same side of the web are arranged in direct succession along the path of the web.

The invention relates to a web-fed rotary printing press in accordance with the preambles of claims 1, 9, 10, 22, 24 or 26.

A web-fed rotary printing press in satellite construction is known from EP 0 710 558 B1, wherein both sides of a paper web pass sequentially through 8 print positions, thus the web runs through 16 print positions. The web sequentially runs through the two printing towers in 4/4 paper guidance, and for the imprinting function the printing towers as a whole can each be placed against or away from the web.

DE 43 03 904 C2 shows the arrangement of two printing groups arranged on top of each other, wherein a paper web running through the two printing groups can be imprinted on both sides in four colors at most.

The object of the invention is based on producing a web-fed rotary printing press.

In accordance with the invention, this object is attained by means of the characteristics of claims 1, 9, 10, 22, 24 or 26.

The advantages to be gained by means of the invention reside in particular in that the two print positions which can be interchanged for imprinter operations, or flying printing forme change (called “imprinter operations” in what follows) are placed not too far apart, and the free length of the paper web between the two printing groups is kept short. For example, in the case of a printing tower in satellite construction, the two interchangeable print positions are arranged within a printing tower having eight print positions.

It is advantageous to avoid a long paper path between the two interchangeable print positions, for example from one printing tower to the other, which generally improves the ability to maintain the register or the color register between two print positions. In contrast to alternatingly switching an entire printing tower on and off, more uniform conditions are provided on the processing path as a whole. For example, as uniform as possible a dampening of the paper web is achieved by means of the web-fed rotary printing press of the invention. For example, it is avoided that in a first mode of operation of a so-called 4/4+4/4 paper guidance, a first printing tower dampens the paper web and imprints it completely 4/4 (while the second printing tower is turned off), and in a second mode of operation only the second printing tower imprints the paper web 4/4, so that by means of this considerable differences between the running path of the dampened paper web between the two modes of operation result. This is achieved, for example, by an 8/0+0/8 paper guidance, wherein its own printing tower with the complete imprinter functionality is assigned to the obverse and reverse printing process. The connected, as well as the corresponding disconnected printing group, is arranged in a common printing tower.

In every mode of operation during imprinter operations, at least one print position in each printing tower is advantageously in the print-on position.

Besides dampening by means of dampening agents, other effects, for example the presence of clamping positions, of print-related transverse or linear expansions, of effects because of the application of ink, or other parameters affecting the tension and the conveyance, can be averaged out.

It is particularly advantageous that for all modes of operation during imprinter operations as uniform as possible conditions, and therefore also as uniform as possible tension conditions in the paper web are produced.

The arrangement of the print positions alternatingly printing the same color close to one another, as well as the increased distance between the first and last simultaneously printing print position for both modes of operation, improve the print quality when changing from one to the other mode of operations.

It is furthermore advantageous that at least six successive print positions of a paper side have the same direction of rotation. For example, eight successive print positions of the printing tower turn in the same direction, so that this paper side can be printed in four colors in the one printing tower in one imprinting operation, for example.

Paper paths in which maximally only four satellite or counter-pressure cylinders “roll over” the fresh imprint are advantageous in regard to losses in quality, as well as to a reduction of the deposition of the fresh ink and the washing outlay connected therewith.

With the advantageous embodiment of the web-fed rotary printing press in a satellite construction, the good capability of keeping the register of two successive print positions because of the short distance, for example.

Exemplary embodiments of the invention are represented in the drawings and will be described in greater detail in what follows.

Shown are in:

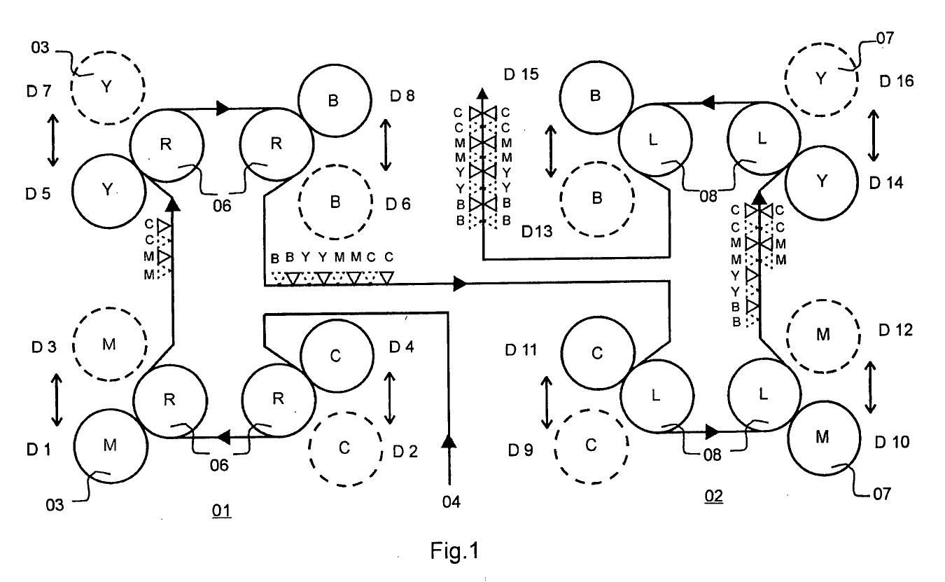

FIG. 1, a first exemplary embodiment for complete imprinter functionality during four-color printing,

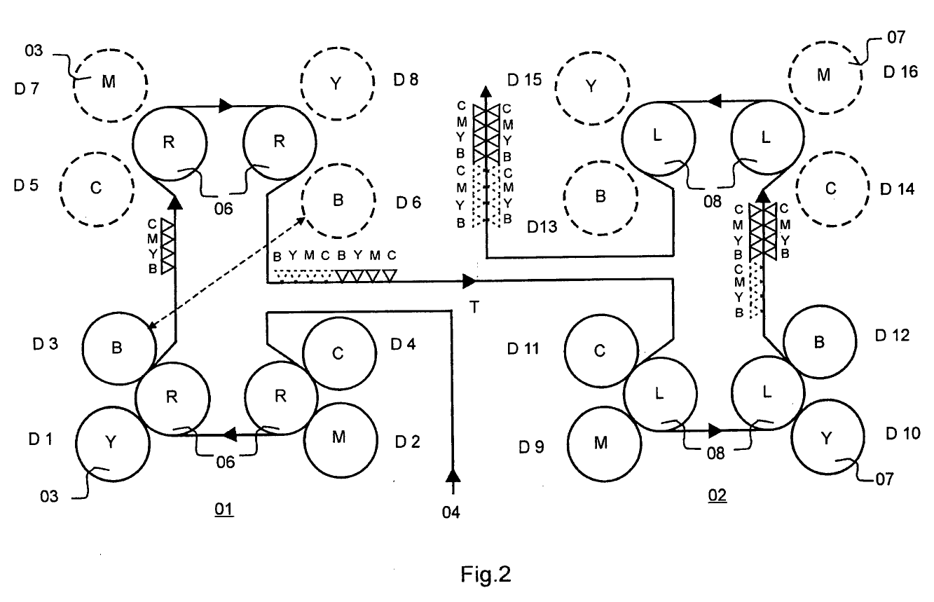

FIG. 2, a second exemplary embodiment for complete imprinter functionality during four-color printing,

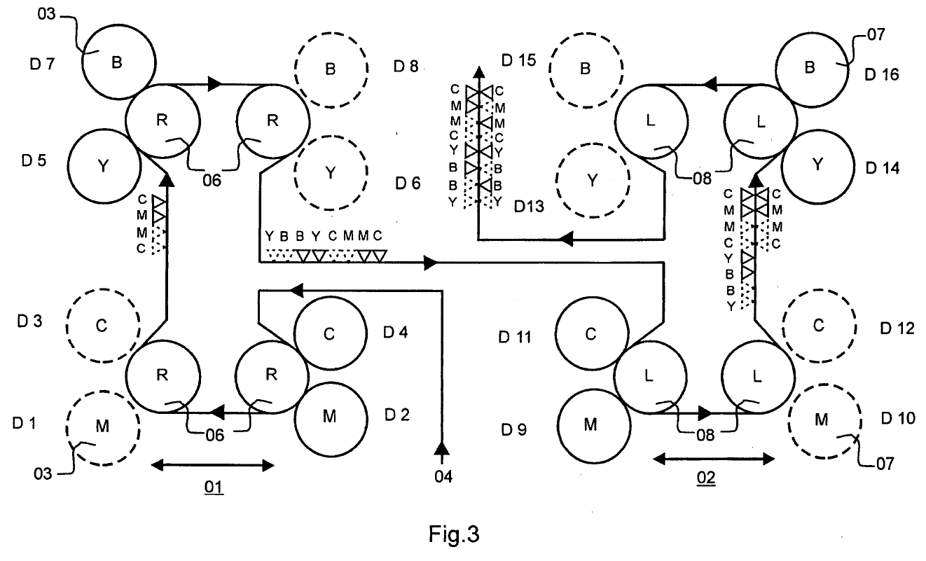

FIG. 3, a third exemplary embodiment for complete imprinter functionality during four-color printing.

A printing press, in particular a web-fed rotary printing press, has a first unit 01, for example a first printing tower 01, and a further unit 02, for example a second printing tower 02. The first printing tower 01 has at least six, in the example eight, print positions D1, D2, D3, D4, D5, D6, D7, D8, which are constituted by eight cylinders 03, for example eight transfer cylinders 08, and satellite cylinders 06, for example steel cylinders 06, working together with them in a print-on position via a drawn-in web 04, for example material to be imprinted, in particular a paper web 04. If the web-fed rotary printing press is designed for n-color printing, the unit 01 has 2·n (two times n) print positions D1, D2, D3, D4, D5, D6, D7, D8 for complete imprinter functionality. For n-color printing on one side of the paper web 04 with an imprinter functionality of m colors (m≦n), the unit 01 has n+m print positions. In the example (FIG. 1) for at least one-sided four-color printing with full imprinter functionality, respectively two adjoining transfer cylinders 03 work together with one of the four steel cylinders 06 and form a total of eight print positions D1, D2, D3, D4, D5, D6, D7, D8. For example, this can be a pair of stacked ten-cylinder satellite units. However, four upper and/or four lower transfer cylinders 03 can also work together with a single transfer cylinder 06 as so-called nine-cylinder satellite units, which are stacked, for example.

The transfer cylinders 03 can be selectively placed against or away from the respective satellite cylinder 06 and work together with forme cylinders, not represented, which in turn work together with ink systems, also not represented, and, if required, with dampening units. For imprinter operations, at least this forme cylinder can be moved away from the transfer cylinder 03 and can be operated at a number of revolutions which differs from at least those of the satellite cylinder 06, so that it can be braked, stopped, if required operated in the opposite direction or at a different number of revolutions, independently of the satellite cylinder 06, for example for changing the printing forme or the print image. In the course of changing the printing forme or the print image (for example image application), the satellite cylinder 06 and, if required the transfer cylinder 03, can continue to be operated at production rpm.

The second unit 02, for example the second printing tower 02, having at least one, but preferably four or eight further print positions D9, D10, D11, D12, D13, D14, D15, D16, is arranged upstream or downstream of the first printing tower 01 along the path of the paper web 04. The same as the first printing tower 01, the second printing tower 02 has cylinders 07, for example transfer cylinders 07, which can be placed against satellite cylinders 08, for example steel cylinders 08.

In the first printing tower 01, the paper web 04 passes through the eight print positions D1, D2, D3, D4, D5, D6, D7, D8 in such a way that it loops around the satellite cylinder 06 in the same direction, in the example to the right R, i.e. in a clockwise direction, in respect to a conveying direction T of the paper web 04. All satellite cylinders 06 rotate in this direction, the paper web 04 can only be imprinted on the side facing the transfer cylinder 08, theoretically eight times.

However, in this first printing tower 01 the paper web 04 is only imprinted on this one side and only four times in four colors in four of these eight print positions D1, D2, D3, D4, D5, D6, D7, D8, while the remaining four print positions D5, D6, D7, D8, D1, D2, D3, D4 can be refitted “on the fly”, i.e. during production. The non-printing print positions D5, D6, D7, D8, D1, D2, D3, D4 use the same four colored inks as the printing ones.

In the first exemplary embodiment (FIG. 1), the print positions D1, D2, D3, D4, D5, D6, D7, D8 with the same colored ink, which are assigned to each other and are in the print-on and in the print-off position (represented in dashed lines and removed from the satellite cylinder), are arranged next to each other and work together with the same satellite cylinder 06.

For example, the two print positions D1, D3 adjoining each other on the bottom left are furnished with magenta M, the two print positions D2, D4 adjoining each other on the bottom right are furnished with cyan C, the two print positions D5, D7 adjoining each other on the top left are furnished with yellow Y, and the two adjoining each other on the top right are furnished with black B.

The two print positions D1, D2, D3, D4, D5, D6, D7, D8 with the same colored ink can be selectively placed against the associated satellite cylinder 06 so that, for example, the side of the paper web 04 facing the transfer cylinder 06 is printed in four colors by the printing groups D1, D4, D5 and D8 placed against it, while the printing groups D2, D3, D6 and D7 are moved away and can therefore be refitted, and vice versa (indicated by the two-headed arrow in the drawing figure).

The arrangement of pairs of print positions D1, D2, D3, D4, D5, D6, D7, D8 with the same colored ink is also possible in any other desired sequence within the first printing tower 01. The distance between the print positions D1, D2, D3, D4, D5, D6, D7, D8 with the same colored ink, which can be alternatingly put into contact, is reduced to a minimum, for example less than 1 m, which results in a minimization of possibly occurring moisture problems in the course of switching from one mode of operation to the other.

After the one-sided imprinting of the paper web in the first printing tower 01, the paper web 04 passes through the second printing tower 02. Depending on the needs, the second unit 02 has one or several, for example at least four, in the example eight, print positions D9, D10, D11, D12, D13, D14, D15, D16, wherein the paper web 04 passes through the print positions D9, D10, D11, D12, D13, D14, D15, D16 in such a way that the side of the paper web 04 which had not yet been imprinted can be imprinted by the transfer cylinders 07. For this purpose, the satellite cylinders 08 of the second printing tower 02 all rotate in the same direction, for example in the direction of rotation toward the left L.

However, in the example the coverage with ink is the same as in the printing tower 01, but is mirrored along the vertical direction. Again, for the purpose of imprinter functions, the transfer cylinders 07 can be placed against, or away from the associated satellite cylinder 08 alternatingly and in pairs.

Thus the paper web 04 is imprinted in the first printing tower 01 and in the second printing tower 02 respectively on one side and in four colors, with full imprinter functionality. The travel distance for moistening the paper web 04, in this case between the printing groups D4 and D7, and between D2 and D5, is not, or only insignificantly changed in comparison with the path length from the first printing group D4 to the last printing group D15 when a change is made from the one mode of operation to the other. The distance between the first and the last printing group which is in the print-on position, for example D4 to D15, or D2 to D13, is greater in both modes of operation than half the distance from the first to the last printing group D1 to D16 assigned to the paper web 04.

The location of moistening in particular is changed only insignificantly in the course through the printing press, which results in a more uniform web tension before and after the switching. In this way the danger of a web break between the units 01 and 02 during switch-over, as well as an increased control outlay, can therefore be reduced.

In the second exemplary embodiment (FIG. 2), the paper web 04 passes around the satellite cylinder 04 of the first printing tower 01 in the same direction, i.e. to the right R, and can be imprinted on one side by all eight print positions D1, D2, D3, D4, D5, D6, D7, D8. The same applies to the guidance of the paper web 04 (but to the left L) and the print positions D9, D10, D11, D12, D13, D14, D15, D16 in the second printing tower 02.

However, the respectively two print positions D1, D2, D3, D4, D5, D6, D7, D8, D9, D10, D11, D12, D13, D14, D15, D16 with the same colored ink per printing tower 01, 02, which can be alternatingly placed into and out of operation, are not arranged directly adjoining and working together with the same satellite cylinder 06, 08, but instead are arranged within the respective printing tower 01, 02 in a diagonally mirror-like way (indicated in FIG. 1 by means of the dashed arrow in the unit 01). In the example, the print positions D1 and D8 in the first printing tower 01, and the print positions D10 and D15 in the second printing tower 02 contain the color yellow Y, the print positions D2 and D7 in the first printing tower 01 and the print positions D9 and D16 in the second printing tower 02 the color magenta M, the print positions D3 and D6 in the first printing tower 01 and the print positions D12 and D13 in the second printing tower 02 the color black B, and the print positions D4 and D5 in the first printing tower 01 and the print positions D11 and D14 in the second printing tower 02 the color cyan C.

A mode of operation is advantageous in which in one state the four print positions D1, D2, D3, D4, D5, D6, D7, D8, respectively arranged on the bottom, are in the print-on position, while the upper print positions D9, D10, D11, D12, D13, D14, D15, D16 are accessible for refitting, and vice versa. Therefore the print positions D1, D2, D3, D4, D5, D6, D7, D8, D9, D10, D11, D12, D13, D14, D15, D16 which are respectively to be refitted are located almost on one level, or on a service level of the printing press.

The printing groups D1, D2, D3, D4, D5, D6, D7, D8, D9, D10, D11, D12, D13, D14, D15, D16 with one colored ink, which alternatingly work together with the same side of the paper web 04, are respectively located within a unit 01, 02. The maximum distance between these two printing groups D1, D2, D3, D4, D5, D6, D7, D8, D9, D10, D11, D12, D13, D14, D15, D16 is therefore less than half the length of the paper web 04 from the first to the last print position D1, D2, D3, D4, D5, D6, D7, D8, D9, D10, D11, D12, D13, D14, D15, D16. The distribution of moisture is more uniform for both modes of operation than if the paper web 04 were imprinted once only by means of the unit 01, and the other time only by means of the other unit in 4/4 operations. The distance between the first and the last of the printing group D4 and D12, or D5 and D13, which are in the contacted position, is greater in both modes of operation of the imprinter operation than half the distance between the first and the last printing group D1, D2, D3, D4, D5, D6, D7, D8, D9, D10, D11, D12, D13, D14, D15, D16, for example D4 and D13. It is advantageous that in both modes of operation at least one of the printing groups D1, D2, D3, D4, D5, D6, D7, D8, D9, D10, D11, D12, D13, D14, D15, D16 is in the contact position and therefore moistens the paper web 04.

In the third exemplary embodiment (FIG. 3), the paper web 04 passes around the satellite cylinders 04, 08 of the first printing tower 01 and the second printing tower 02 also respectively in the same direction, for example to the right R in the first printing tower 01 and to the left L in the second printing tower 02.

However, the respectively two print positions D1, D2, D3, D4, D5, D6, D7, D8, D9, D10, D11, D12, D13, D14, D15, D16 with the same colored ink per printing tower 01, 02, which can be alternatingly placed into and out of operation, are arranged within the respective printing tower 01, 02 mirrored along the vertical line. In the example, the print positions D1 and D2 in the first printing tower 01, and the print positions D9 and D10 in the second printing tower 02 contain the color magenta M, the print positions D3 and D4 in the first printing tower 01 and the print positions D11 and D12 in the second printing tower 02 the color cyan C, the print positions D5 and D6 in the first printing tower 01 and the print positions D13 and D14 in the second printing tower 02 the color yellow Y, and the print positions D7 and D8 in the first printing tower 01 and the print positions D15 and D16 in the second printing tower 02 the color black B.

A mode of operation is advantageous wherein in one state the print positions D2, D4, D5, D7, D9, D11, D14, D16 located diagonally opposite each other inside the respective printing tower 01, 02 are in the print-on position, while the other diagonally oppositely located print positions D1, D3, D6, D8, D10, D12, D13, D15 are accessible for refitting and vice versa. Thus, the print positions D1, D3, D6, D8, D10, D12, D13, D15 to be respectively refitted are not located directly adjoining the print positions D2, D4, D5, D7, D9, D11, D14, D16 or D1, D3, D6, D8, D10, D12, D13, D15 on which the production runs, which makes less demands on safety precautions.

Again, the printing groups D1, D2, D3, D4, D5, D6, D7, D8, D9, D10, D11, D12, D13, D14, D15, D16 with one colored ink, which alternatingly work together with the same side of the paper web 04, are respectively located within a unit 01, 02. Here, too, the maximum distance between these two printing groups D1, D2, D3, D4, D5, D6, D7, D8, D9, D10, D11, D12, D13, D14, D15, D16 is less than half the length of the paper web 04 from the first to the last print position D1, D2, D3, D4, D5, D6, D7, D8, D9, D10, D11, D12, D13, D14, D15, D16. The local distribution of moisture is uniform for both modes of operation. Here, too, the distance between the first and the last of the printing groups, for example D4 and D16, or D1 and D13, which are in the contacted position, is greater in both modes of operation of the imprinter operation than half the distance between the first and the last printing groups D1, D2, D3, D4, D5, D6, D7, D8, D9, D10, D11, D12, D13, D14, D15, D16, for example D4 and D13.

It is advantageous that in both modes of operation always at least one of the printing groups D1, D2, D3, D4, D5, D6, D7, D8, D9, D10, D11, D12, D13, D14, D15, D16 is in a contacted position and therefore moistens the paper web 04.

If, differing from the four-color print on both sides, a production with full imprinter functionality is desired, other configurations of the first unit 01 and the second unit 02 are also conceivable. If, for example, this requirement must be met for only one side of the paper web 04, with only a four-color imprint without imprinter functionality, or a two-color imprint with full imprinter functionality, on the other side, the second unit 02 can be reduced to four print positions D9, D10, D11, D12, or the other print positions D13, D14, D15, D16 of a second unit 02 embodied as a printing tower 02 can work together with a second paper web, not represented, from a printing tower, also not represented, which corresponds to the first printing tower 01.

It is also possible to equip at least one of the units 01, 02 for more than four colored inks, for example for n=6 colored inks with, for example, two-color imprinter capability (m=2) on one side of the paper web 04, so that this unit 01, 02 has eight print positions, through all of which the web 04 runs in the same direction of rotation. The same applies correspondingly to the requirement of less than four colored inks, for example three colored inks with six print positions D1, D2, D3, D4, D5, D6, with full imprinter functionality.

However, for every configuration it is advantageous if the two printing groups D1, D2, D3, D4, D5, D6, D7, D8, D9, D10, D11, D12, D13, D14, D15, D16, which correspond or can be alternatingly placed against a side of the paper web, have a distance which is short, in particular less than half the length of the paper path between the first and the last printing group D1, D2, D3, D4, D5, D6, D7, D8, D9, D10, D11, D12, D13, D14, D15, D16, working together with the paper web 04. But the area of moistening, i.e. the length of the paper web 04 between the first and last contacting print position D1, D2, D3, D4, D5, D6, D7, D8, D9, D10, D11, D12, D13, D14, D15, D16, must be greater than half the above mentioned length in each one of the two operating situations.

If the printing groups D1, D2, D3, D4, D5, D6, D7, D8, D9, D10, D11, D12, D13, D14, D15, D16 for both sides of the paper web 04 are arranged in two different, for example structurally separate, units 01, 02, at least one printing group D1, D2, D3, D4, D5, D6, D7, D8, D9, D10, D11, D12, D13, D14, D15, D16 must be in the contacting position in each unit 01, 02 in each one of the two operating situations. In this case it is advantageous if its own unit 01, 02 is assigned to the respective obverse and reverse printing process, wherein the guidance of the paper web 04 around the satellite cylinder 06, 08 inside the respective units 01, 02 takes place in the same direction.

It is furthermore advantageous if first all n (n=3, 4, 5, 6), in the examples four, colored inks Y, B, M, Y are applied to one side of the web 04 before the other side is imprinted.

In a further development of the invention (not represented), several printing groups with respective pairs with the same colored ink B, C, M, Y, can be arranged in a bridge construction (rubber-against-rubber operation), wherein four such printing groups, which imprint the same side of the paper web 04, are embodied in two colors, for example. These printing groups with the same colored ink are advantageously arranged respectively next to each other in the running direction of the paper web. Since printing and non-printing printing groups are not completely spatially separated in the running direction of the paper web 04, but are alternatingly arranged, for example, it is advantageous that here, too, in the course of a change from the one to the other mode of operation during imprinter operations.

In the same way the exemplary embodiments mentioned can be applied to an imprinter operation wherein no alternating printing in the sense of a flying plate change (for example for printing different regional versions of a newspaper) is intended, but the insertion of an additional printed image (added text, decorative color). In this case the printing group which, for example, is only activated at certain times, should be arranged near printing groups printing on the same side, particularly advantageous directly next to them. In the sense of averaging out the conditions on the web 04, when employing several such printing groups for one side of the web 04 it is advantageous not to arrange them together upstream of the first or downstream of the last “normal” printing group.

List of Reference Symbols

01 Unit, first, printing tower

02 Unit, second, printing tower

03 Cylinder, transfer cylinder

04 Web, paper web

05 −

06 Satellite cylinder, steel cylinder

07 Cylinder, transfer cylinder

08 Satellite cylinder, steel cylinder

D1 Print position (01)

D2 Print position (01)

D3 Print position (01)

D4 Print position (01)

D5 Print position (01)

D6 Print position (01)

D7 Print position (01)

D8 Print position (01)

D9 Print position (02)

D10 Print position (02)

D11 Print position (02)

D12 Print position (02)

D13 Print position (02)

D14 Print position (02)

D15 Print position (02)

D16 Print position (02)

B Black

C Cyan

M Magenta

Y Yellow

L Turning to the left

R Turning to the right

T Conveying direction (04)

1. A web-fed rotary printing press for imprinting a web (04), having at least two satellite cylinders (06, 08) and at least six cylinders (03, 07), which constitute respective print positions (D1 to D16) together with the satellite cylinders (06, 08), wherein at least two of the print positions (D1 to D16) can be alternatingly actuated, by means of which in a respective print-on position the same colored ink (B, C, M, Y) can be applied to the same side of the web (04), characterized in that a distance along the path of the web (04) between the first and the last print position (D1 to D16), which are simultaneously in the print-on position, is greater that half the length of the path of the web (04) between the first and the last of the print position (D1 to D16) assigned to the web (04).

2. The rotary printing press in accordance with claim 1, characterized in that the two print positions (D1 to D16), which apply the same colored ink (B, C, M, Y) to the same side of the web (04) in the print-on position, are arranged in a first unit (01).

3. The rotary printing press in accordance with claim 1, characterized in that the two print positions (D1 to D16), which apply the same colored ink (B, C, M, Y) to the same side of the web (04) in the print-on position, are arranged in a first printing tower (01).

4. The rotary printing press in accordance with claim 1, characterized in that the first and the last print position (D1 to D16), which are in the print-on position at the same time, are arranged along the path of the web (04) in two different units (01, 02), through which the web (04) passes.

5. The rotary printing press in accordance with claim 1, characterized in that the first and the last print position (D1 to D16), which are in the print-on position at the same time, are arranged along the path of the web (04) in two different printing towers (01, 02), through which the web (04) passes.

6. The rotary printing press in accordance with claim 3, characterized in that six print positions (D1 to D16), which place ink applications on the same side of the web (04) in the print-on position, are arranged in the first printing tower (01).

7. The rotary printing press in accordance with claim 6, characterized in that at least five of the six print positions (D1 to D16), which place ink applications on the same side of the web (04) in the print-on position, are arranged in direct sequence on the path of the web (04).

8. The web-fed rotary printing press in accordance with claim 5, characterized in that the first printing tower (01), which has the first print position (D1 to D8) in the print-on position, has at least six, and the second printing tower (02), which has the second print position (D9 to D16) in the print-on position, has at least four print positions (D9 to D16).

9. A web-fed rotary printing press for printing on a web (04), which has at least four print positions (D1 to D16) which, during imprinter operations, are assigned to the same web 04, in two printing towers (01, 02), wherein at least two of the print positions (D1 to D16) can be alternatingly put into operation for an imprinter operation, by means of which in a print-on position the same colored ink (B, C, M. Y) can be applied to the same side of the web (04), characterized in that at least one of the print positions (D1 to D16) of each printing tower (01, 02) is in the print-on position in each one of the two modes of operation of the imprinter operation.

10. A web-fed rotary printing press for printing on a web (04), which has at least two satellite cylinders (06, 08), and at least six cylinders (03, 07) which, together with the satellite cylinders (06, 08), in the print-on position form a print position (D1 to D16), which applies colored ink (B, C, M, Y) to the same side of the web (04), by means of which in a respective print-on position the same colored ink (B, C, M, Y) can be applied to the same side of the web (04), characterized in that at least five of the print positions (D1 to D16), which place colored ink (B, C, M, Y) on the same side of the web (04) in the print-on position, are arranged in direct sequence on the path of the web (04).

11. The web-fed rotary printing press in accordance with claim 1, 9 or 10, characterized in that the maximum distance between the two printing groups (D1 to D16), which in the print-on position apply the same colored ink (B, C, M, Y) to the same side of the web (04), is less than half the length of the web (04) from the first to the last print position (D1 to D16) assigned to the web (04).

12. The web-fed rotary printing press in accordance with claim 10, characterized in that the at least six print positions are arranged in one unit (01, 02).

13. The web-fed rotary printing press in accordance with claim 10, characterized in that the at least six print positions are arranged in a first printing tower (01, 02).

14. The web-fed rotary printing press in accordance with claim 12, characterized in that the web (04) is arranged to pass through a second unit (02, 01) with at least four further print positions (D9 to D16).

15. The web-fed rotary printing press in accordance with claim 5 or 14, characterized in that by means of the print positions (D9 to 16) of the second unit (02, 01) assigned to the path of the web (04), colored ink (B, C, M, Y) can be applied to the side of the web (04) which is opposite the side imprinted in the first unit.

16. The web-fed rotary printing press in accordance with claim 14, characterized in that the first unit (01) and the second unit (02) are each embodied as a printing tower (01, 02), each with eight print positions (D1 to D16).

17. The web-fed rotary printing press in accordance with claim 3, 9 or 13, characterized in that the satellite cylinders (06, 08) of a printing tower (01, 02) all have the same direction of rotation (L, R).

18. The web-fed rotary printing press in accordance with claim 14, characterized in that a first side of the web (04) can be exclusively printed in the first unit (01, 02), and a second side of the web (04) can be exclusively printed in the second unit (02, 01).

19. The web-fed rotary printing press in accordance with claim 16, characterized in that each of the printing towers (01, 02) is embodied in the form of nine-cylinder satellite units (01, 02) stacked in pairs and each has two satellite cylinders (06, 08) and eight transfer cylinders (03, 07), which work together with the two satellite cylinders (06, 08).

20. The web-fed rotary printing press in accordance with claim 16, characterized in that each of the printing towers (01, 02) is embodied in the form of ten-cylinder satellite units (01, 02) stacked in pairs and each has four satellite cylinders (06, 08) and eight transfer cylinders (03, 07), which work together with the four satellite cylinders (06, 08).

21. The web-fed rotary printing press in accordance with claim 2 or 12, characterized in that in a first operating mode half the print positions (D1 to D16) of the unit (01, 02) are in the print-on position, and in a second operating mode the other half of the print positions (D1 to 16).

22. A web-fed rotary printing press having at least two satellite cylinders (06, 08) and at least six cylinders (03, 07), which together with the satellite cylinders (06, 08) constitute respectively print positions (D1 to D16), by means of which in a respective print-on position the same colored ink (B, C, M, Y) can be applied to the same side of the web (04), characterized in that the satellite cylinders (06, 08) of at least five successive print positions (D1 to D16) have the same direction of rotation (L, R).

23. The web-fed rotary printing press in accordance with claim 22, characterized in that in a first operating mode four of the eight print positions (D1 to D16) of a printing tower (01, 02) are arranged so they imprint the web (04) on one side, and in a second operating mode the other four print positions (D16 to Dl) of the same printing tower (01) imprint it on one side.

24. A web-fed rotary printing press which has at least four print positions (D1 to D16) in a direct sequence on the path of the web (04), which apply colored ink (B, M, C, Y) to a web (04), wherein in the print-on position by means of pairs of at least four of the print positions (D1 to D16) the same colored ink (B, C, M, Y) can be applied alternatingly to the same side of the web (04), characterized in that at least two of the print positions (D1 to D16) with the same colored ink (B, M, C, Y) are arranged directly next to each other along the travel path of the web (04).

25. The web-fed rotary printing press in accordance with claim 24, characterized in that all print positions (D1 to D16) with the same colored ink (B, M, C, Y) are arranged directly next to each other along the travel path of the web (04).

26. A web-fed rotary printing press, which has at least eight print positions (D1 to D16), which in the print-on position apply colored ink (B, M, C, Y) to a web (04), wherein in the print-on position by means of pairs of at least eight of the print positions (D1 to D16) the same colored ink (B, C, M, Y) can be applied alternatingly to the same side of the web (04), characterized in that in a first operating mode the first four print positions (D1 to D16) along the travel path of the web (04), and in a second operating mode the next four print positions (D1 to D16) along the travel path of web (04) are arranged to apply colored ink (B, M, C, Y) to the same side of the web (04).
